(19) United States
(12) Patent Application Publication
(10) Pub. No.: US 2016/0080111 A1
(43) Pub. Date: Mar. 17, 2016

(54) RECEIVER, TRANSMITTER AND DATA TRANSMISSION SYSTEM

(71) Applicant: FUJITSU LIMITED, Kawasaki-shi (JP)

(72) Inventors: Shigeyuki MAEDA, Yokohama (JP); Takanori ISHll, Nerima (JP); Tomoyuki KANAYAMA, Kawasaki (JP)

(73) Assignee: FUJITSU LIMITED, Kawasaki (JP)

(21) Appl. No.: 14/826,570

(22) Filed: Aug. 14, 2015

(30) Foreign Application Priority Data
Sep. 12, 2014 (JP) 2014-186448

(51) Int. Cl. H04L 1/00

(52) U.S. Cl. CPC H04L 1/0045; H04L 1/0041

(57) ABSTRACT

A receiver includes a processor. The processor is configured to receive first data blocks and a first parity block from a transmitter. The first data blocks are obtained by dividing first transmission data at a predetermined size. The first parity block is generated on basis of the first data blocks. The processor is configured to restore a first missing block on basis of first received blocks and the first parity block. The first missing block is an unsuccessfully received block of the first data blocks. The first received blocks are successfully received blocks of the first data blocks. The first parity block is successfully received.

### CROSS-REFERENCE TO RELATED APPLICATION

This application is based upon and claims the benefit of priority from the prior Japanese Patent Application No. 2014-186448 filed on Sep. 12, 2014, the entire contents of which are incorporated herein by reference.

### FIELD

The embodiments discussed herein are related to a receiver, a transmitter and a data transmission system.

### BACKGROUND

In the art of data transmission via buses or networks, many techniques for improving reliability of data transmission have been known. For example, there is a technique in which a transmitting side transmits data with a cyclic redundancy check (CRC) code and a receiving side uses the CRC code to detect errors of the received data. As another example, there is a technique in which a transmitting side transmits a packet with a sequence number and a receiving side returns the sequence number of the packet which has been successfully received or returns a sequence number of a packet which has been unsuccessfully received, based on the sequence number of the packet which has been successfully received.

As for the techniques related to the data transmission, the following proposals have been made as well. For example, there has been proposed a technique for transmitting a plurality of undefined length datagrams added with a header indicating datagram size to an extension board via a peripheral components interconnect (PCI) bus. There has been also proposed a technique for dividing transmission data into blocks and adding a parity bit for error detection to each of a plurality of divided data constituting each block data.

Related techniques are disclosed in, for example, Japanese Laid-Open Patent Publication No. H 10-293741 and Japanese Laid-Open Patent Publication No. 2011-103509.

### SUMMARY

According to an aspect of the present invention, provided is a receiver including a processor. The processor is configured to receive first data blocks and a first parity block from a transmitter. The first data blocks are obtained by dividing first transmission data at a predetermined size. The first parity block is generated on basis of the first data blocks. The processor is configured to restore a first missing block on basis of first received blocks and the first parity block. The first missing block is an unsuccessfully received block of the first data blocks. The first received blocks are successfully received blocks of the first data blocks. The first parity block is successfully received.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a data transmission system according to a first embodiment;

FIG. 2 is a diagram illustrating a storage system according to a second embodiment;

FIG. 3 is a diagram illustrating an example of hardware of a CM;

FIG. 4 is a diagram illustrating an example of hardware of a communication circuit;

FIG. 5 is a diagram illustrating an example of re-division of integrated data and additional information;

FIG. 6 is a diagram illustrating an example of block reception process;

FIG. 7 is a diagram illustrating additional information used in the second embodiment;

FIG. 8 is a diagram illustrating an example of a determination process based on a code;

FIG. 9 is a diagram illustrating an example of functions of a transmitting side communication circuit;

FIG. 10 is a diagram illustrating an example of functions of a receiving side communication circuit;

FIG. 11 is a diagram illustrating an example of a transmission table;

FIG. 12 is a diagram illustrating an example of a code management table;

FIG. 13 is a diagram illustrating an example of an in-process table;

FIG. 14 is a diagram illustrating an example of a reserve table;

FIG. 15 is a flowchart illustrating an example of a transmission process;

FIG. 16 is a flowchart illustrating an example of a reception process;

FIG. 17 is a flowchart illustrating an example of a reception process;

FIG. 18 is a flowchart illustrating an example of a reception process;

FIG. 19 is a flowchart illustrating an example of a monitoring process;

FIG. 20 is a diagram illustrating an example of a reception process; and

FIG. 21 is a diagram illustrating an example of a reception process.

### DESCRIPTION OF EMBODIMENTS

The above-described techniques such as adding a CRC code to data or adding a sequence number to a packet have a problem that the receiving side is required to cause the transmitting side to retransmit the data when reception of the data is failed. The same applies to the above-described technique of adding a parity bit to each of the plurality of divided data. Techniques requiring retransmission of data which has been unsuccessfully received cause congestion of data transmission lines which raises problems such as reduction of data transmission rates or increase of processing times of entire processes involving data transmission.

Hereinafter, embodiments of the present disclosure will be described with reference to the drawings.

### First Embodiment

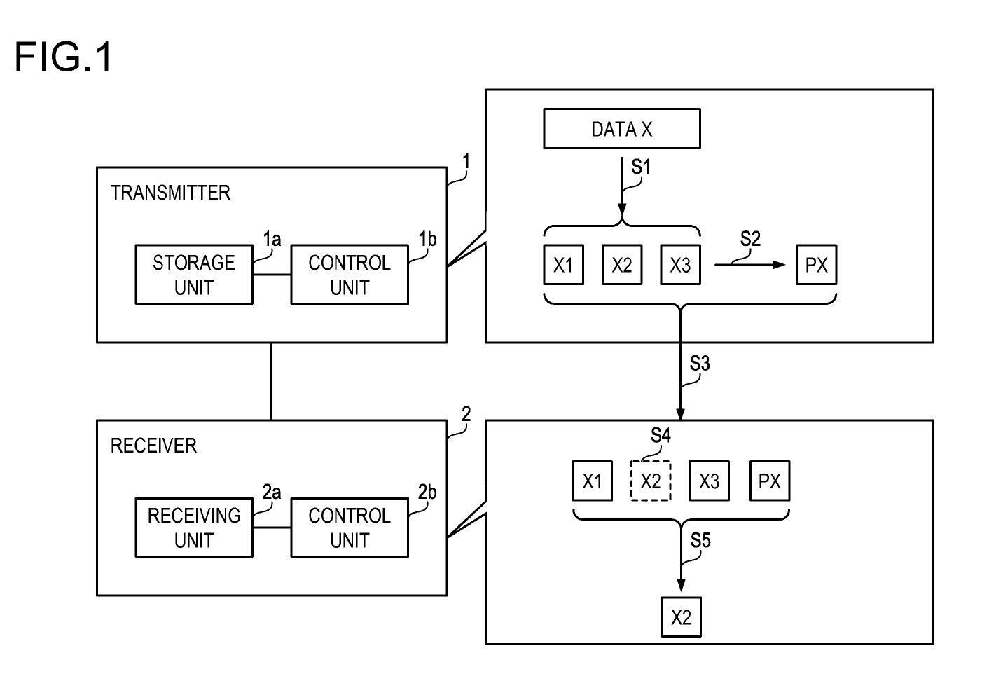

FIG. 1 is a diagram illustrating a data transmission system according to a first embodiment. The data transmission system includes a transmitter 1 and a receiver 2. The transmitter 1 and the receiver 2 are interconnected via a bus or a network.

The transmitter 1 includes a storage unit is and a control unit 1b. The receiver 2 includes a receiving unit 2a and a control unit 2b. The storage unit is may be a volatile memory device such as, for example, a random access memory (RAM), or may be a nonvolatile memory device such as, for example, a hard disk drive (HDD) or a flash memory. The control units 1b and 2b may each include a central processing unit (CPU), a digital signal processor (DSP), an application specific integrated circuit (ASIC), and a field programmable gate array (FPGA). The receiver 2 also includes a volatile memory device and a nonvolatile memory device.

In the transmitter 1, the storage unit is stores plural transmission data to be transmitted to the receiver 2. For example, the storage unit is may be implemented as a transmission buffer which temporarily stores the transmission data to be transmitted.

The control unit 1b divides the transmission data stored in the storage unit is into data blocks, each of which has a specified size. The control unit 1b generates one or more data blocks for each of the transmission data. The control unit 1b generates a parity block based on data blocks corresponding to the same transmission data among the generated data blocks. The control unit 1b transmits the generated one or more data blocks and the parity block for each of the transmission data.

In the receiver 2, the receiving unit 2a receives the data blocks and the parity block transmitted from the transmitter 1. When the control unit 2b fails to receive one data block among the data blocks and the parity block corresponding to the same transmission data, the control unit 2b restores the data block which has been unsuccessfully received, based on the other data blocks and the parity block which correspond to the same transmission data and have been successfully received.

The following method is to allow the control unit 2b to determine the data blocks and the parity block corresponding to the same transmission data among the data blocks and the parity blocks which have been received by the receiving unit 2a. For example, the control unit 1b of the transmitter 1 adds group identification information, which indicates that the data blocks and the parity block belong to the same group, to the data blocks and the parity block corresponding to the same transmission data, and transmits the data blocks and the parity block added with the group identification information to the receiver 2. The receiving unit 2a of the receiver 2 receives the transmitted data blocks and parity block. The control unit 2b of the receiver 2 determines the data blocks and the parity block corresponding to the same transmission data on the basis of the group identification information added to the data blocks and the parity block received by the receiving unit 2a.

Hereinafter, an example of detailed processing will be described with reference to FIG. 1. FIG. 1 illustrates a transmission of data X from the transmitter 1 to the receiver 2. The control unit 1b of the transmitter 1 divides the data X into data blocks X1 to X3 (S1). The control unit 1b generates a parity block PX on the basis of the data blocks X1 to X3 (S2). The control unit 1b transmits the data blocks X1 to X3 and the parity block PX to the receiver 2 (S3).

It is here assumed that the receiver 2 has received the data blocks X1 and X3 and the parity block PX successfully but has failed to receive the data block X2 (S4). Examples of the unsuccessful reception may include, for example, loss of the data block X2 on a transmission line, or a failure in storing the data block X2 in a storage device of the receiver 2 although the data block X2 has been received successfully by the receiver 2.

In a case where receiving the data block X2 is failed, the control unit 2b of the receiver 2 uses the data blocks X1 and X3 and the parity block PX, which have been successfully received, to restore the data block X2 which has been unsuccessfully received (S5). This substantially results in a successful reception of the data X, eliminating a need of retransmission of the data X from the transmitter 1.

According to the above-described first embodiment, the transmission data are divided into plural data blocks and a parity block is generated based on the plural data blocks. The data blocks obtained by the dividing and the parity block based on the obtained data blocks are transmitted from the transmitter 1 to the receiver 2. Therefore, even in a case where reception of one of data blocks corresponding to single transmission data is failed, the receiver 2 may use the other data blocks and the parity block, which correspond to the transmission data and have been successfully received, to restore the data block which has been unsuccessfully received. When the unsuccessfully received data block is restored, it is not necessary to cause the transmitter 1 to retransmit the corresponding transmission data.

Therefore, according to the first embodiment, it is possible to reduce the frequency of retransmission of the transmission data from the transmitter 1 to the receiver 2. This may result in, for example, mitigation of communication traffics between the transmitter 1 and the receiver 2, thereby increasing a transmission rate. This may also result in a reduction of the processing time of the entire predetermined information processing by the transmitter 1, including the transmission of the transmission data.

### Second Embodiment

Next, as for a system including the transmitter 1 and the receiver 2 according to the first embodiment, a storage system will be described.

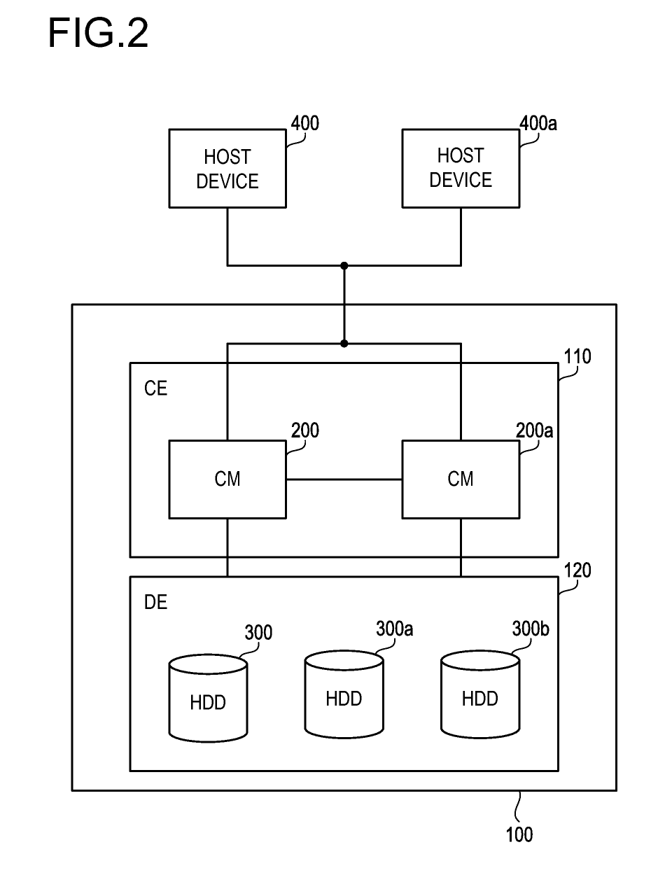

FIG. 2 is a diagram illustrating a storage system according to a second embodiment. The storage system according to the second embodiment includes a storage device 100 and host devices 400 and 400a.

The storage device 100 and the host devices 400 and 400a are interconnected via a cable such as, for example, a serial attached small computer interface (SAS), or a fibre channel (FC). This connection configuration may be called direct attached storage (DAS). The storage device 100 and the host devices 400 and 400a may be interconnected via, for example, a storage area network (SAN) using FC or Internet small computer interface (iSCSI). The storage device 100 may be used as network attached storage (NAS).

The storage device 100 includes a controller enclosure (CE) 100 and a drive enclosure (DE) 120. The CE 110 includes controller modules (CMs) 200 and 200a.

The CMs 200 and 200a control, for example, the data access to the DE 120 at a request from the host devices 400 and 400a, and operations of hardware modules in the storage device 100. Such redundancy of the CMs 200 and 200a having the same function may contribute to increase the reliability of the access operation from the host devices 400 and 400a to the DE 120.

The CMs 200 and 200a are interconnected and configured such that information stored in one CM, such as cached data or predetermined setting data, is also stored in the other CM. In such a state where data are exchanged between the CM 200 and the CM 200a, one of the CMs 200 and 200a is one example of the transmitter 1 of the first embodiment and the other is one example of the receiver 2.

The DE 120 includes HDDs 300, 300a and 300b. The number of HDDs included in the DE 120 is not limited to three. The host devices 400 and 400a are client computers used by users. The host devices 400 and 400a request an access to the HDDs 300 to 300b included in the DE 120 of the storage device 100.

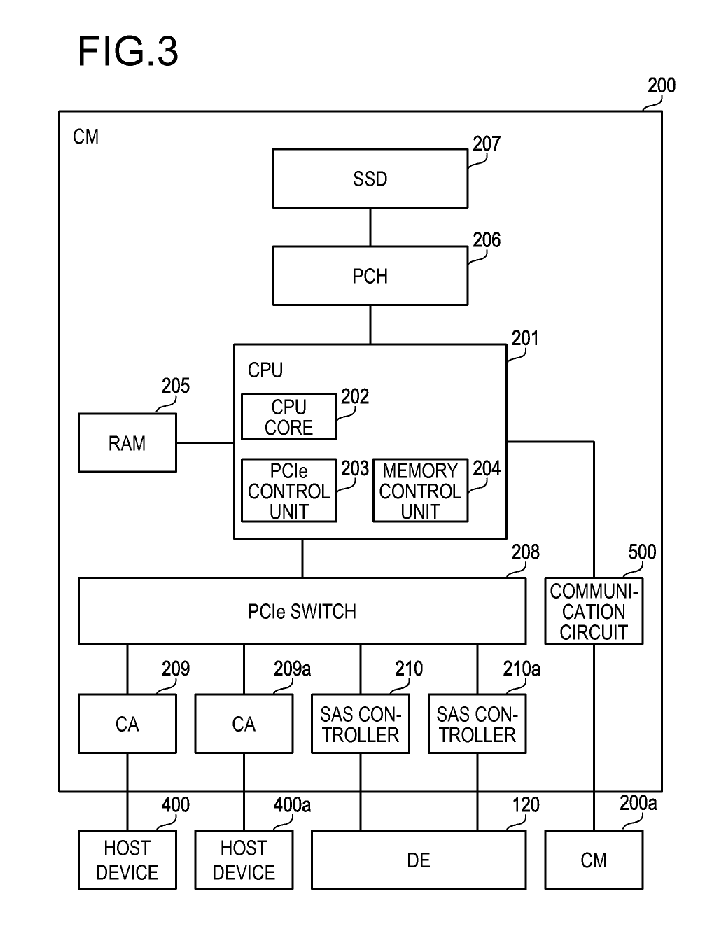

FIG. 3 is a diagram illustrating an example of hardware of a CM. The CM 200 includes CPU 201, RAM 205, a platform controller hub (PCH) 206, a solid state drive (SSD) 207, a PCI express (PCIe) switch 208, channel adapters (CAs) 209 and 209a, SAS controllers 210 and 210a and a communication circuit 500.

The RAM 205 is connected to the CPU 201. The SSD 207 is connected to the CPU 201 via the PCH 206. The CAs 209 and 209a and the SAS controllers 210 and 210a are connected to the CPU 201 via the PCIe switch 208. The CM 200a is connected to the CPU 201 via the communication circuit 500.

The CPU 201 includes a CPU core 202, a PCIe control unit 203 and a memory control unit 204. The CPU core 202 controls information processing of the CM 200. The PCIe control unit 203 uses a PCIe protocol to conduct communication with the PCH 206, the PCIe switch 208 and the communication circuit 500. For example, the PCIe control unit 203 transmits data added with a PCIe header to the communication circuit 500. The memory control unit 204 controls reading or writing of data stored in the RAM 205.

The RAM 205 is a main memory of the CM 200. The RAM 205 is a volatile semiconductor memory. The RAM 205 temporarily stores at least a portion of a program of an operating system (OS) and application programs which are executed by the CPU core 202. The RAM 205 also stores a variety of data used for processing by the CPU core 202.

The PCH 206 exchanges data between the CPU 201 and the SSD 207. A local area network (LAN) interface may be connected to the PCH 206.

The SSD 207 is an auxiliary memory of the CM 200. The SSD 207 is a nonvolatile semiconductor memory. The SSD 207 stores the program of the OS, the application programs and a variety of data. Instead of the SSD 207, the CM 200 may include an HDD as an auxiliary memory.

The PCIe switch 208 exchanges data between the CPU 201 and the CAs 209 and 209a/SAS controllers 210 and 210a. The CA 209 is an interface for communication with the host device 400 and the CA 209a is an interface for communication with the host device 400a. The SAS controllers 210 and 210a are interfaces for communication with HDDs in the DE 120.

The communication circuit 500 is an interface for communication with the CM 200a. The communication circuit 500 exchanges data between the CPU 201 and the CM 200a. The communication circuit 500 is connected to the CPU 201 and the CM 200a via PCIe buses. The communication circuit 500 transmits data stored in the RAM 205 of the CM 200 to the CM 200a so as to request to copy the data to a RAM (not illustrated) of the CM 200a and receives data stored in the RAM of the CM 200a so as to copy the received data into the RAM 205 of the CM 200.

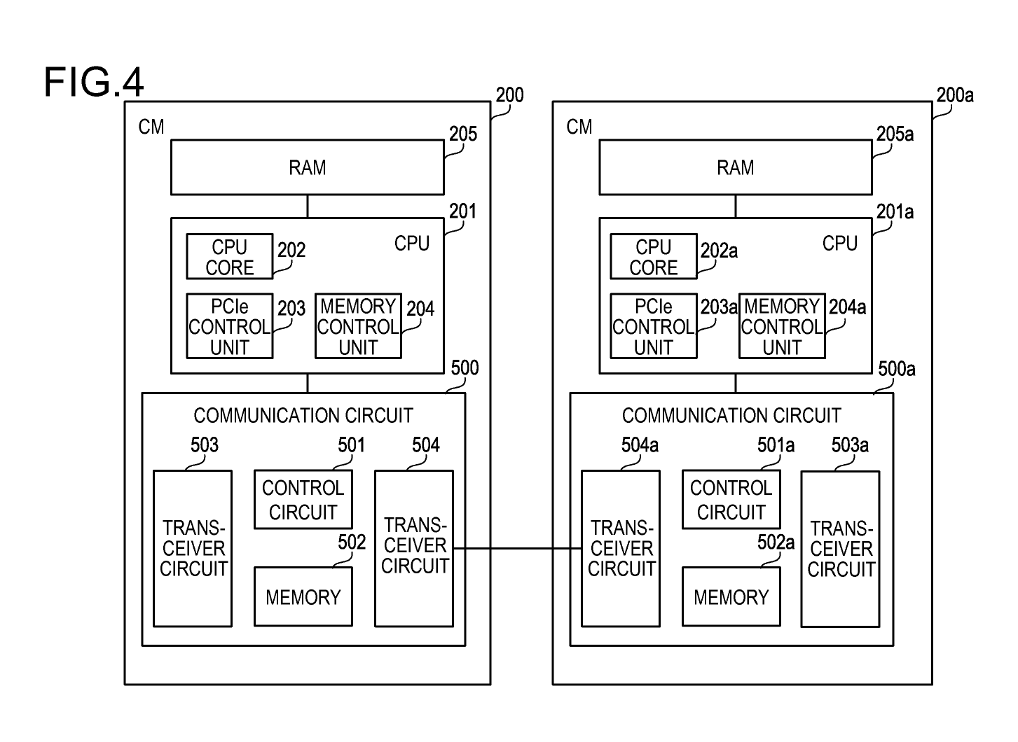

The CM 200a is implemented with similar hardware to that of the CM 200. FIG. 4 is a diagram illustrating an example of hardware of communication circuits. FIG. 4 illustrates an example of hardware of communication circuits 500 and 500a included respectively in the CMs 200 and 200a. The communication circuit 500a is hardware corresponding to the communication circuit 500. The communication circuit 500 and the communication circuit 500a are interconnected via a PCIe bus. FIG. 4 also illustrates the CPU 201 and RAM 205 of the CM 200, and a CPU 201a and a RAM 205a of the CM 200a, in addition to the communication circuits 500 and 500a. The CPU 201a and the RAM 205a are hardware corresponding to the CPU 201 and the RAM 205, respectively.

The communication circuit 500 includes a control circuit 501, a memory 502 and transceiver circuits 503 and 504. The communication circuit 500a includes a control circuit 501a, a memory 502a and transceiver circuits 503a and 504a. The CPU 201 and the CPU 201a exchange data via the communication circuit 500 and the communication circuit 500a.

The control circuit 501 is a circuit to control information processing of the communication circuit 500, such as division of data, addition of additional information, detection and correction of errors in received data, and so on. The memory 502 is a volatile semiconductor memory. For example, the memory 502 may be a RAM. The memory 502 stores a variety of data used for processing by the control circuit 501. The memory 502 is also used as a buffer for temporarily storing transmission data and reception data. The transceiver circuit 503 is a communication interface circuit for controlling data exchange with the CPU 201. The transceiver circuit 504 is a communication interface circuit for controlling data exchange with the CM 200a.

The control circuit 501a is a circuit to control information processing of the communication circuit 500a, such as division of data, addition of additional information, detection and correction of errors in received data, and so on. The memory 502a is a volatile semiconductor memory. For example, the memory 502a may be a RAM. The memory 502a stores a variety of data used for processing by the control circuit 501a. The memory 502a is also used as a buffer for temporarily storing transmission data and reception data. The transceiver circuit 503a is a communication interface circuit for controlling data exchange with the CPU 201a. The transceiver circuit 504a is a communication interface circuit for controlling data exchange with the CM 200.

The data transmission processing performed by the above-mentioned communication circuits 500 and 500a is mainly to transmit predetermined data stored in one of the RAMs 205 and 205a to the other of the RAMs 205 and 205a for backup. Examples of data stored in the RAM, which is to be backed up, may include cached data in the RAM for data access processing at a request from the host devices 400 and 400a, and a variety of setting data related to the operation of the corresponding CM.

Hereinafter, a flow from transmission of data stored in the RAM 205 by the control circuits 501 and 501a to storage of the data in the RAM 205a will be described. The control circuit 501 receives a data transmission request of transmitting data on the RAM 205, from the CPU core 202 via the transceiver circuit 503. The data transmission request includes, for example, a head address of transmission data stored in the RAM 205, a length of the transmission data, and an address in the RAM 205a as a transmission destination.

The control circuit 501 transmits a read request for the transmission data, via the transceiver circuit 503, based on the received information. The read request is transmitted to the memory control unit 204 via the PCIe control unit 203. The memory control unit 204 reads requested data from the RAM 205 and transmits the read data to the communication circuit 500 via the PCIe control unit 203. The transmitted data are received by the transceiver circuit 503 and are stored in a buffer area of the memory 502.

The data transmitted from the PCIe control unit 203 to the communication circuit 500 at the read request is divided and stored in payloads of PCIe packets. In the communication circuit 500, the data in the payloads of the received PCI packets are integrated for the moment by stored in the memory 502.

The control circuit 501 again divides the integrated data into data blocks of a specified size. This re-division is to add additional information, which will be described later, to a data block in a payload when the integrated data are transmitted to the communication circuit 500a as PCIe packets. Therefore, the size of a data block is smaller by the size of the additional information than the size of a payload. In addition, the control circuit 501 generates a parity block on the basis of data blocks obtained by the re-division of the integrated data.

The control circuit 501 transmits the data blocks and the parity block, as PCIe packets indicating a write request for writing data in the RAM 205a, to the communication circuit 500a via the transceiver circuit 504. Either the data block or the parity block is stored along with the additional information in a payload of each PCIe packet.

The transmitted PCIe packets are received by the transceiver circuit 504a of the communication circuit 500a and stored in a buffer area of the memory 502a. Based on the additional information, the control circuit 501a determines data blocks and a parity block corresponding to the same transmission data and determines the existence of data blocks which have been unsuccessfully received. When all data blocks have been successfully received, it is assumed that the transmission data have been normally received. When one data block has been unsuccessfully received, the control circuit 501a uses other data blocks and the parity block, which have been successfully received, to restore the data block which has been unsuccessfully received. Even in this case, it is assumed that the transmission data have been normally received. In this manner, when only one data block corresponding to the transmission data has been unsuccessfully received, the corresponding data block may be restored, eliminating a need of retransmission of the transmission data from the CM 200.

When the transmission data have been normally received, the control circuit 501a outputs, via the transceiver circuit 503a, a write request for writing the data in the RAM 205a. The write request is transmitted to the memory control unit 204a via the PCIe control unit 203a and the memory control unit 204a writes the data in the RAM 205a. The transmission data, which have been normally received, is divided again by the control circuit 501a, stored in PCIe packets, and then transmitted to the PCIe control unit 203a.

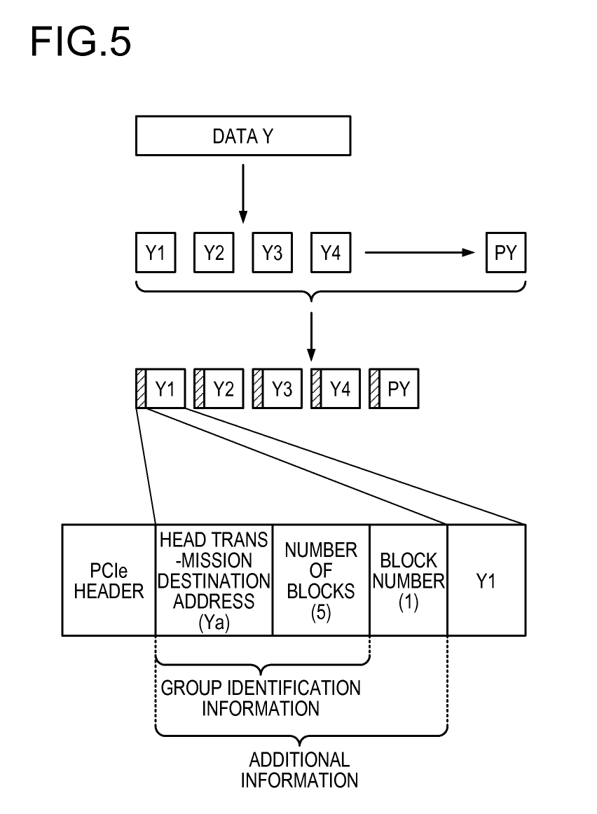

FIG. 5 is a diagram illustrating an example of re-division of the integrated data and additional information. In the following description, a data block and a parity block may be collectively referred to as a “block” unless particularly distinguished from each other.

In the example of FIG. 5, it is assumed that transmission of data Y stored in the RAM 205 is requested from the CPU core 202. According to the above-described procedure, the data Y read from the RAM 205 are transmitted by the PCIe packets from the PCIe control unit 203 to the communication circuit 500 and are integrated in the memory 502 of the communication circuit 500 for the moment.

The control circuit 501 divides the integrated data Y again into data blocks of a specified size. In the example of FIG. 5, it is assumed that four data blocks Y1 to Y4 are generated by the re-division. The control circuit 501 generates a parity block PY on the basis of the data blocks Y1 to Y4. The parity block PY is calculated, for example, according to an expression of “Y1 XOR Y2 XOR Y3 XOR Y4”. Where, “XOR” represents performing an exclusive OR operation for each bit.

The control circuit 501 adds additional information to each of the data blocks Y1 to Y4 and the parity block PY. The additional information is includes group identification information which allows a receiving side to identify that the transmitted data blocks Y1 to Y4 and the parity block PY belong to the same group corresponding to the same data (the data Y in this example). By setting the group identification information having different numeric values for different groups, the receiving side may identify a group to which a received block belongs.

As one example of such group identification information, a “head transmission destination address” as illustrated in FIG. 5 may be considered. The head transmission destination address is a head address of a storage area in the RAM 205a of the corresponding data Y and has a value common to all blocks belonging to the same group. In the example of FIG. 5, it is assumed that the head transmission destination address is “Ya”. As the head transmission destination address, an address specified by the CPU core 202 at a request for transmission of the data Y may be used as it is. Therefore, the control circuit 501 may eliminate a need to perform a separate process of generating the group identification information and may add the group identification to the additional information easily.

It may be also considered to include the “number of blocks” in the group identification information, as illustrated in FIG. 5. The number of blocks refers to the total number of blocks belonging to the same group and is a value common to all blocks belonging to the same group. In the example of FIG. 5, the number of blocks is “5”. Alternatively, the number of blocks may be the total number of data blocks belonging to the same group.

The receiving side may use the “number of blocks” in the additional information to recognize the number of blocks belonging to the same group as well as to identify blocks belonging to the same group. In this manner, by including information available for other purposes in the group identification information, the size of the additional information may be decreased, thereby reducing an overhead for transmission.

In addition, it may be considered to further include a “block number” in the additional information, as illustrated in FIG. 5. The block number represents a serial number of each of blocks belonging to the same group. Therefore, different blocks belonging to the same group have different block numbers. A block number added to the parity block may not be a serial number but may be, for example, a preset value (for example, “0”).

The additional information as mentioned above is stored in the payload of the PCIe packet, together with the parity block PY or one of the data blocks Y1 to Y4. The control circuit 501 transmits each PCIe packet including the additional information and the blocks to the communication circuit 500a. A head address of a write area of a data block stored in the RAM 205a of the transmission destination, as a head address of a write destination, is described in the PCIe head of the PCIe packet in which the data block is stored.

The PCIe packets as mentioned above are received by the transceiver circuit 504a of the communication circuit 500a and are stored in the buffer area of the memory 502a. The control circuit 501a of the communication circuit 500a determines whether or not five blocks set with the head transmission destination address “Ya”, and the number of blocks “5” are written in the memory 502a by referring to the additional information.

When the five blocks are written, the control circuit 501a determines that the data Y has been normally received. When only four blocks are written, for example, the control circuit 501a may identify a block which has been unsuccessfully received, by checking the block number in order by referring to the “block number” in the additional information. At this time, for example, when the data block Y3 has been unsuccessfully received, the control circuit 501a may use the received data blocks Y1, Y2 and Y4 and the parity block PY to restore the data block Y3. In this manner, even when one data block in a group has been unsuccessfully received, the control circuit 501a may restore the data block.

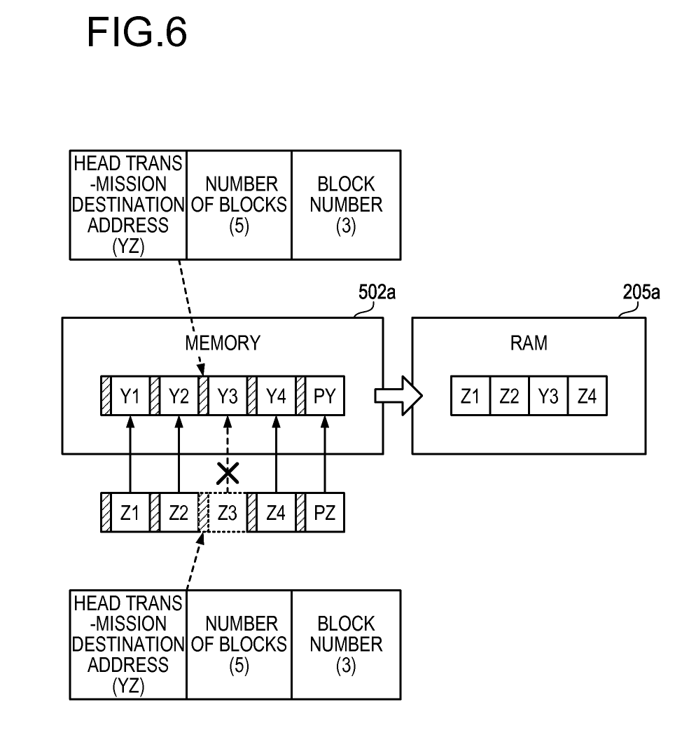

However, as illustrated in FIG. 6, there is a case where the control circuit 501a does not correctly determine a failure in receiving a data block. This case is likely to occur when transmission of data to the same memory area on the RAM 205a is continuously requested.

FIG. 6 is a diagram illustrating an example of block reception process. In the example of FIG. 6, it is assumed that data blocks Y1 to Y4 and a parity block PY corresponding to data Y are transmitted from the communication circuit 500 of the CM 200 to the communication circuit 500a of the CM 200a. It is also assumed that the transceiver circuit 504a of the communication circuit 500a correctly stores the received data blocks Y1 to Y4 and the parity block PY, together with additional information, in the buffer area of the memory 502a.

Among the additional information added to the data blocks Y1 to Y4 and the parity block PY, group identification information is set with a head transmission destination address “YZ” and the number of blocks “5”. In addition, for example, additional information added to the data block Y3 is set with the block number “3”.

The control circuit 501a sequentially reads the additional information added to the blocks stored in the memory 502a. The control circuit 501a determines, based on the additional information added to the data blocks Y1 to Y4 and the parity block PY, that the four data blocks Y1 to Y4 having the group identification information set with the head transmission destination address “YZ” and the number of blocks “5” are all included. In this case, the control circuit 501a transmits the data blocks Y1 to Y4 to the RAM 205a.

Next, it is assumed that transmission of data Z (not illustrated) from the CPU core 202 of the CM 200 to the communication circuit 500 is requested. It is also assumed that the data Z have the same memory area of transmission destination as the data Y which have been previously requested for transmission. That is, it is assumed that the data Z have the same head address “YZ” of transmission destination area designated from the CPU core 202 and the same data length as the data Y.

In this case, the control circuit 501 of the communication circuit 500 divides the data Z into data blocks Z1 to Z4 and uses the data blocks Z1 to Z4 to generate a parity block PZ. The control circuit 501 adds additional information to the data blocks Z1 to Z4 and the parity block PZ and transmits them to the communication circuit 500a. In this case, among the additional information added to the blocks, group identification information is set with a head transmission destination address “YZ” and the number of blocks “5”. The transceiver circuit 504a of the communication circuit 500a stores the received data blocks Z1 to Z4 and the parity block PZ, together with the additional information, in the buffer area of the memory 502a.

Here, there is a case where the transceiver circuit 504a writes the data blocks Z1 to Z4 and the parity block PZ in the same memory area as the data blocks Y1 to Y4 and the parity block PY in the memory 502a. Such writing may be attributed to a small memory capacity of the memory 502a. The memory 502a is used for both of block transmission and reception and is also used as a memory area of data required for processing of the control circuit 501a. Therefore, it may be considered that the capacity of the memory area available as a reception buffer of data received from the communication circuit 500 becomes smaller.

In the example of FIG. 6, it is assumed that an event of writing of the data blocks Z1 to Z4 and the parity block PZ in the same memory area as the data blocks Y1 to Y4 and the parity block PY on the memory 502a has occurred. It is, however, assumed that the transceiver circuit 504a has failed to write the data block Z3 of these blocks Z1 to Z4 in the memory 502a. It is further assumed that the control circuit 501a recognizes that the data block Z3 has been successfully written without recognizing the failure of writing in the transceiver circuit 504a. Such an error in writing may be attributed to noises in the transceiver circuit 504a and abnormality of the transceiver circuit 504a.

In the event of writing error of the data block Z3, the data blocks Y1, Y2 and Y4 and the parity block PY are respectively overwritten by the data blocks Z1, Z2 and Z4 and the parity block PZ on the memory 502a. The additional information added to the blocks Y1, Y2, Y4 and PY are also overwritten by new additional information. However, the data block Y3 and its additional information are left in the memory 502a without being overwritten.

In this state, the control circuit 501a detects the head transmission destination address “YZ” and the number of blocks “5” from the additional information of the data block Z1. The control circuit 501a determines whether or not there exist five blocks with “YZ” set in the “head transmission destination address” in the additional information, by referring to the additional information of the data blocks and the parity block PZ. The control circuit 501a reads the additional information in the order of the data blocks Z2, Y3, Z4 and the parity block PZ since the control circuit 501a does not recognize the writing error of the data block Z3.

The additional information of the data block Y3 stored in the memory 502a has the same contents as the additional information of the data block Z3 which has failed in overwriting. Therefore, the head transmission destination address “YZ” and the number of blocks “5” are set in the additional information of the data blocks Z1, Z2, Y3 and Z4 and the parity block PZ. Accordingly, the control circuit 501a makes an incorrect determination that there exist five blocks added with the head transmission destination address “YZ” and the number of blocks “5”.

The control circuit 501a stores the data blocks Z1, Z2, Y3 and Z4 in the area on the RAM 205a in which the data blocks Y1, Y2, Y3 and Y4 are stored. Then, there occurs an event where only the memory area of the data block Y3 in the RAM 205a is not updated by the data block Z3.

In this manner, when transmission of data to the same memory area on the RAM 205a is continuously requested, and blocks and additional information corresponding to the subsequent data are written in the same memory area on the memory 502a of the communication circuit 500a, a data block whose writing in the memory 502a is erroneously skipped is not detected based on the additional information. Therefore, there may occur an event where a portion (the memory area for the data block Y3) of the RAM 205a is not updated.

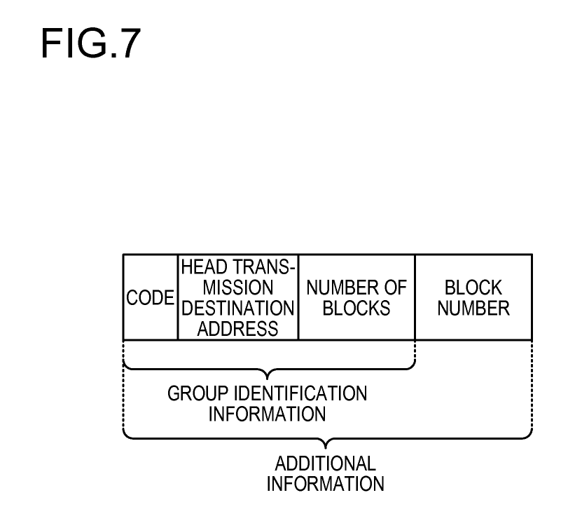

According to the present embodiment, the event where the portion of the RAM 205a is not updated may be avoided by adding a code to the additional information. FIG. 7 is a diagram illustrating additional information according to the second embodiment. FIG. 7 illustrates addition of a code to the “group identification information” in the additional information illustrated in FIGS. 5 and 6. The code is set with “0” or “1”. A value set in the code is not limited to “0” or “1” as long as the code has one of any two predetermined value.

The value of the code is changed every time one transmission data is transmitted from the communication circuit 500 to the communication circuit 500a. For example, the control circuit 501 adds additional information set with a code “0” to the data blocks Y1 to Y4 into which the data Y is divided, and the parity block PY, and transmits them to the communication circuit 500a. Next, the control circuit 501 adds additional information set with a code “1” to the data blocks Z1 to Z4 into which the data Z is divided, and the parity block PZ, and transmits them to the communication circuit 500a. In this manner, the control circuit 501 changes the “code” in the additional information every time the transmission data are changed.

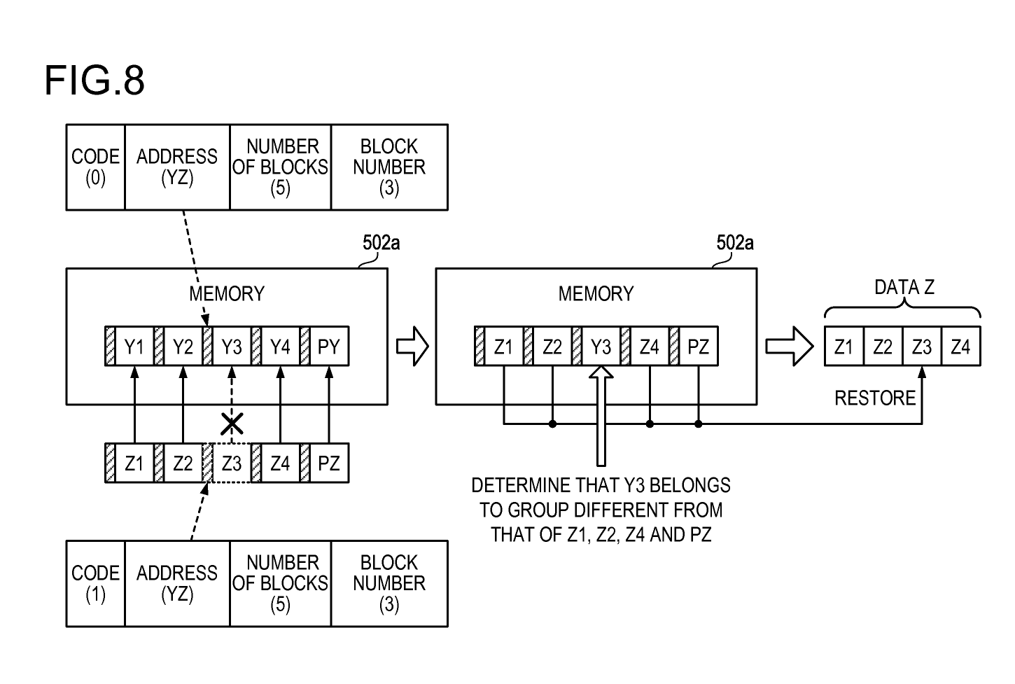

FIG. 8 is a diagram illustrating an example of processing of determination based on a code. FIG. 8 illustrates a case, as illustrated in the example of FIG. 6, where transmission of the data Y is first requested and transmission of the data Z having the same size as the data Y to the same memory area as the data Y on the RAM 205a is then requested. It is assumed that the control circuit 501 of the communication circuit 500 sets a code “0” in additional information of blocks corresponding to the data Y and sets a code “1” in additional information of blocks corresponding to the next data Z.

In the state of the left side of FIG. 8, at a request for transmission of the data Y, the data blocks Y1, Y2, Y3 and Y4 and the parity block PY are normally stored, together with the additional information, in the memory 502a of the communication circuit 500a. In this state, transmission of the data Z is requested and the control circuit 501 of the communication circuit 500 transmits the data blocks Z1, Z2, Z3 and Z4 and the parity block PZ, together with the additional information, to the communication circuit 500a.

In the communication circuit 500a, like the example of FIG. 6, it is assumed that the received data blocks Z1, Z2, Z3 and Z4 and the parity block PZ are stored in the same area as the data blocks Y1, Y2, Y3 and Y4 and the parity block PY on the memory 502a. However, as in the example of FIG. 6, it is assumed that the transceiver circuit 504a has failed to write the data block Z3, and the data block Y3 and its additional information are left in the memory 502a, as illustrated in the middle portion of FIG. 5. It is also assumed that the control circuit 501a fails to detect the failure in writing the data block Z3.

The control circuit 501a sequentially reads the additional information of the blocks from the memory 502a. At this time, the data blocks Z1, Z2 and Z4 and the parity block PZ have the same code, address and number of blocks in the corresponding additional information. Therefore, the control circuit 501a determines that the data blocks Z1, Z2 and Z4 and the parity block PZ belong to the same group. However, the data block Y3 has the same address and number of blocks in the corresponding additional information as the data blocks Z1, Z2 and Z4 and the parity block PZ but has a code value different from those of the data blocks Z1, Z2 and Z4 and the parity block PZ. Therefore, the control circuit 501a determines that the data block Y3 belongs to a group different from the group of the data blocks Z1, Z2 and Z4 and the parity block PZ. Then, the control circuit 501a may correctly determine based on the “number of blocks” and the “block number” set in the additional information of the data blocks Z1, Z2 and Z4 and the parity block PZ that the data block Z3 added with the block number “3” has been unsuccessfully received.

Accordingly, the control circuit 501a may use the data blocks Z1, Z2 and Z4 and the parity block PZ to restore the data block Z3 and may write the data blocks Z1 to Z4 in the RAM 205a. Although the data block Z3 has been unsuccessfully received, since the entire data Z are normally written in the RAM 205a, it is unnecessary to retransmit the data Z from the CM 200.

In this manner, by checking the inclusion of all blocks belonging to the same group on the basis of the “code”, the “head transmission destination address”, and the “number of blocks” in the additional information, the failure in reception process may be determined. Since the control circuit 501a controls the data block, which has been unsuccessfully received, not to be transmitted to the RAM 205a, it is possible to avoid an event where a portion of the RAM 205a is not updated.

The transmitting side control circuit 501 may invert a value of each bit of the additional information other than the code only when the code has predetermined one of the two values. For example, when the code is “1”, the control circuit 501 inverts a value of each bit of the additional information other than the code. In this case, the receiving side control circuit 501a determines whether or not each bit of the additional information other than the code is inverted, based on the value of the “code” in the additional information. If it is determined that each bit is inverted, the control circuit 501a inverts and uses each bit of at least the number of blocks and the block number to determine the number of received blocks belonging to the same group.

When such bit inversion is performed, the receiving side control circuit 501a may make a comparison of the group identification information, without each bit of the group identification information inverted, even if the code is “1” in determination of blocks belonging to the same group. For example, when the above-described bit inversion is not performed in the case of FIG. 8, the group identification information added to the data blocks Z1, Z2 and Z4 and the parity block PZ is different in only the code value from the group identification information added to the data block Y3. In contrast, when the above-described bit inversion is performed, the group identification information added to the data blocks Z1, Z2 and Z4 and the parity block PZ is different in the entire group identification information from the group identification information added to the data block Y3. Accordingly, for example, even when only the code in the group identification information is changed due to an error occurring in transmission on a transmission line or writing in the memory 502a, it may be detected that the data block Y3 does not belong to the group to which the data blocks Z1, Z2 and Z4 and the parity block PZ belong. In other words, the entire group identification information plays a role equivalent to the code, which may result in improved accuracy of error detection.

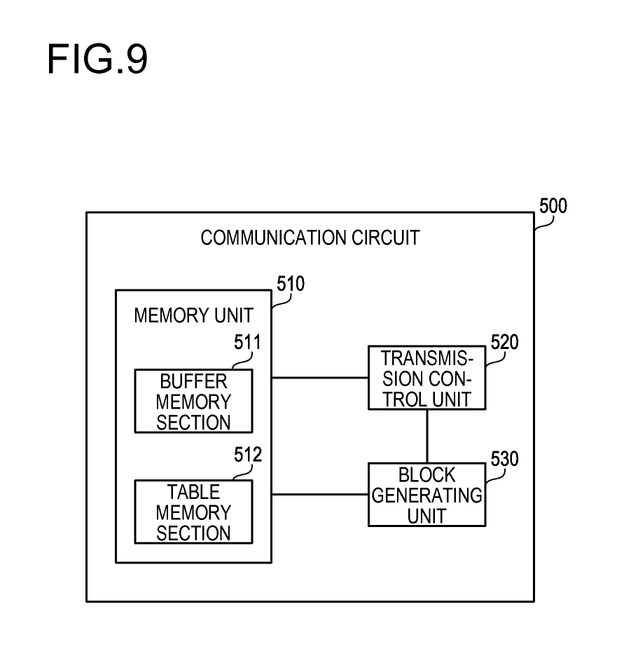

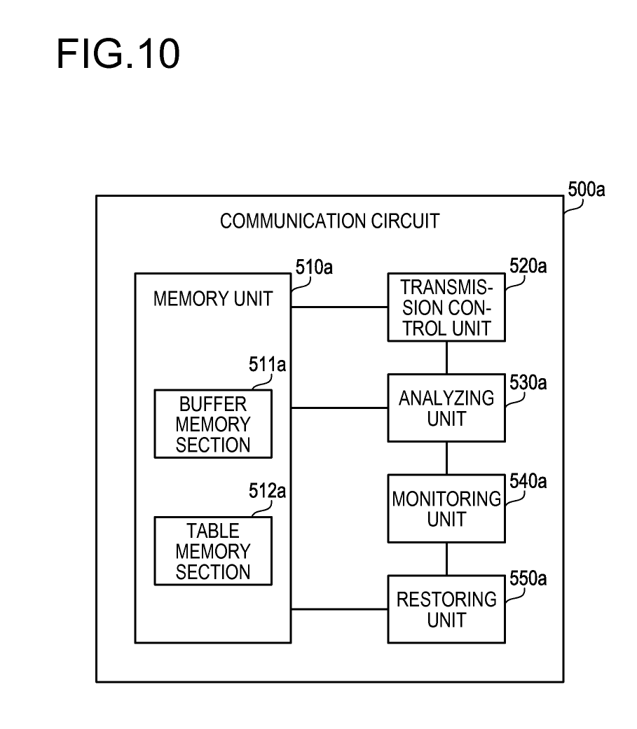

Next, the functions of the communication circuits 500 and 500a will be described with reference to FIGS. 9 and 10. The communication circuits 500 and 500a have the same functions. However, in FIGS. 9 and 10, for the purpose of simplicity of description, the communication circuit 500 and the communication circuit 500a are respectively illustrated as a transmitting side and a receiving side and description of the functions of the communication circuit 500 as the receiving side and the communication circuit 500a as the transmitting side will be omitted.

FIG. 9 is a diagram illustrating an example of functions of the transmitting side communication circuit. The communication circuit 500 includes a memory unit 510, a transmission control unit 520, and a block generating unit 530. For example, the memory unit 510 is provided as a memory area secured in the memory 502. Processing of the transmission control unit 520 and the block generating unit 530 is implemented when a predetermined firmware program is executed by a processor included in the control circuit 501. At least one of the transmission control unit 520 and the block generating unit 530 may be provided as a dedicated circuit.

The memory unit 510 stores information used for the processing of the transmission control unit 520 and the block generating unit 530. The memory unit 510 includes a buffer memory section 511 and a table memory section 512. The buffer memory section 511 temporarily stores, for example, data blocks acquired from the RAM 205. The table memory section 512 stores a transmission table. Information used to generate additional information, such as, for example, a transmission size, information indicating a size of the additional information, and a code, is registered in the transmission table. The transmission size is a data size which may be transmitted by a PCIe packet from the communication circuit 500 to the communication circuit 500a. The transmission size and the additional information size are beforehand registered in the transmission table. The code is a code managed in the transmitting side communication circuit 500.

The transmission control unit 520 receives a data transmission request from the CPU 201. Based on the received data transmission request, the transmission control unit 520 registers a transmission source address and a head transmission destination address in the transmission table. In addition, the transmission control unit 520 requests, via the PCIe control unit 203, the memory control unit 204 to read data requested for transmission. In response to this read request, the data are read from the RAM 205 and transmitted to the communication circuit 500 via the memory control unit 204 and the PCIe control unit 203. The data are transmitted by being divided into PCIe packets and integrated for the moment as data blocks are stored in the memory 502.

The transmission control unit 520 creates additional information by referring to the transmission table and adds the additional information to each of plural data blocks and a parity block which are created by the block generating unit 530 which will be described later. The transmission control unit 520 transmits the data blocks and the parity block added with the additional information to the communication circuit 500a via the transceiver circuit 504. Upon completing the transmission of the data blocks and the parity block, the transmission control unit 520 updates the code registered in the transmission table. For example, the transmission control unit 520 updates a code “0” to a code “1”, and a code “1” to a code “0”.

Based on the transmission size and additional information size registered in the transmission table, the block generating unit 530 again divides the data integrated in the buffer memory section 511 into plural data blocks. The block generating unit 530 generates a parity block on the basis of the data blocks.

FIG. 10 is a diagram illustrating an example of functions of the receiving side communication circuit. The communication circuit 500a includes a memory unit 510a, a transmission control unit 520a, an analyzing unit 530a, a monitoring unit 540a, and a restoring unit 550a. The transmission control unit 520a, the analyzing unit 530a, the monitoring unit 540a, and the restoring unit 550a may communicate with one another.

For example, the memory unit 510a is provided as a memory area secured in the memory 502a. Processing of the transmission control unit 520a, the analyzing unit 530a, the monitoring unit 540a, and the restoring unit 550a is implemented when a predetermined firmware program is executed by a processor included in the control circuit 501a. At least one of the transmission control unit 520a, the analyzing unit 530a, the monitoring unit 540a, and the restoring unit 550a may be provided as a module of a dedicated circuit.

The memory unit 510a stores information used for processing of the transmission control unit 520a, the analyzing unit 530a, the monitoring unit 540a, and the restoring unit 550a. The memory unit 510a includes a buffer memory section 511a and a table memory section 512a. The buffer memory section 511a temporarily stores the data blocks and the parity block transmitted from the communication circuit 500, together with the additional information. The table memory section 512a stores a code management table, an in-process table and a reserve table. Information indicating a code managed in the receiving side communication circuit 500a is registered in the code management table. Information on an in-process group, which is being checked by the analyzing unit 530a that all data blocks belonging to the same group are included, is registered in the in-process table. Information on groups other than the above-mentioned in-process group is registered in the reserve table.

The data blocks and the parity block transmitted from the communication circuit 500 are stored in the buffer memory section 511a, together with the additional information. The transmission control unit 520a performs error detection and error correction of data on the basis of the additional information of the blocks stored in the buffer memory section 511a.

When all of the data blocks belonging to the same group are included, the transmission control unit 520a instructs the transceiver circuit 503a to transmit all of the data blocks. The transceiver circuit 503a transmits all of the data blocks belonging to the same group to the RAM 205a via the PCIe control unit 203a and the memory control unit 204a. When one of the data blocks belonging to the same group has been unsuccessfully received, the transmission control unit 520a acquires a block, which is obtained by restoring that data block, from the restoring unit 550a and transmits the acquired block to the RAM 205a via the transceiver circuit 503a, together with the data blocks which have been successfully received.

The analyzing unit 530a checks a code indicated by the additional information added to the data blocks and the parity block. When the checked code is different from the code registered in the code management table, the analyzing unit 530a registers information on the data blocks and the parity block in the in-process table. On the other hand, when the checked code is equal to the code registered in the code management table, the analyzing unit 530a registers information on the data blocks and the parity block in the reserve table.

When the transmission control unit 520a transmits all of the data blocks belonging to the same group to the RAM 205a via the PCIe control unit 203a and the memory control unit 204a, the analyzing unit 530a updates the code registered in the code management table. For example, the analyzing unit 530a updates a code “0” to a code “1”, and a code “1” to a code “0”.

When the information on the data blocks and the parity block is first registered in the in-process table, the monitoring unit 540a monitors whether or not all of the blocks belonging to the same group are included in the buffer memory section 511a in a predetermined time. When one of the data blocks belonging to the same group is not included in the predetermined time (time-out), the monitoring unit 540a instructs the restoring unit 550a to restore the one data blocks which is not stored in the buffer memory section 511a.

The restoring unit 550a uses the data blocks and the parity block belonging to the same group, which are stored in the buffer memory section 511a, to restore the one data block belonging to the same group, which is not stored in the buffer memory section 511a.

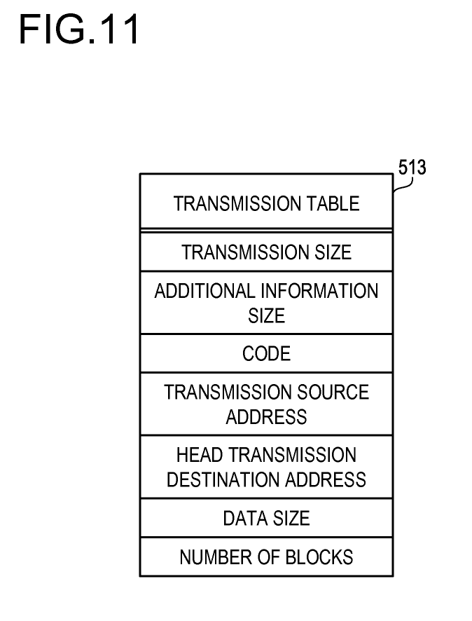

FIG. 11 is a diagram illustrating an example of a transmission table. A transmission table 513 is stored in the table memory section 512. The transmission table 513 includes items such as a “transmission size”, an “additional information size”, a “code”, a “transmission source address”, a “head transmission destination address”, a “data size”, and the “number of blocks”.

Information indicating a transmission size is registered in the item of the “transmission size”. The transmission size indicates a size of data which may be transmitted as a single PCIe packet, that is, a size of payload of a PCIe packet. Information indicating a size of additional information is registered in the item of the “additional information size”. “0” or “1” is registered in the item of the “code”. A transmission source address is registered in the item of the “transmission source address”. A transmission destination address at which a head data block of blocks corresponding to transmission data is stored is registered in the item of the “head transmission destination address”. A size of transmission data is registered in the item of the “data size”. The number of blocks corresponding to transmission data is registered in the item the “number of blocks”.

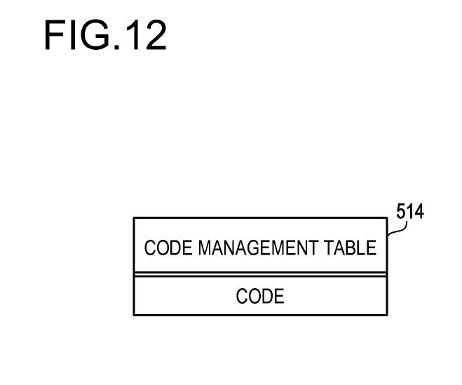

FIG. 12 is a diagram illustrating an example of a code management table. A code management table 514 is stored in the table memory section 512a. The code management table 514 includes an item of the “code”. “0” or “1” is registered in the item of the “code”.

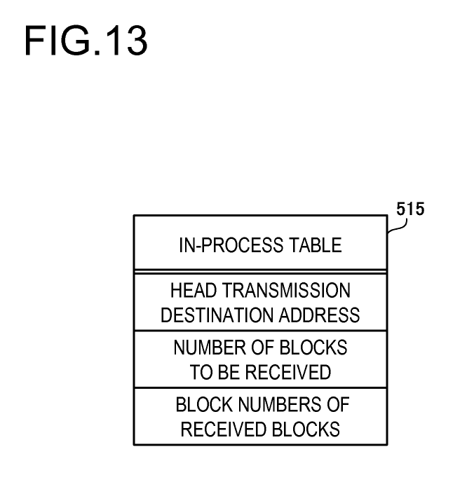

FIG. 13 is a diagram illustrating an example of an in-process table. An in-process table 515 is stored in the table memory section 512a. The in-process table 515 includes items such as a “head transmission destination address”, a “number of blocks to be received”, and “block numbers of received blocks”.

A transmission destination address at which a head data block is stored is registered in the item of the “head transmission destination address”. The number of blocks to be received is registered in the item of the “number of blocks to be received”. Numbers of blocks stored in the buffer memory section 511a by the transmission control unit 520a are registered in the item of the “block numbers of received blocks”.

Specifically, the “head transmission destination address” in the additional information is registered in the item of the “head transmission destination address”. The “number of blocks” in the additional information is registered in the item of the “number of blocks to be received”. The “Block number” in the additional information of received blocks is registered in the item of the “block numbers of received blocks”.

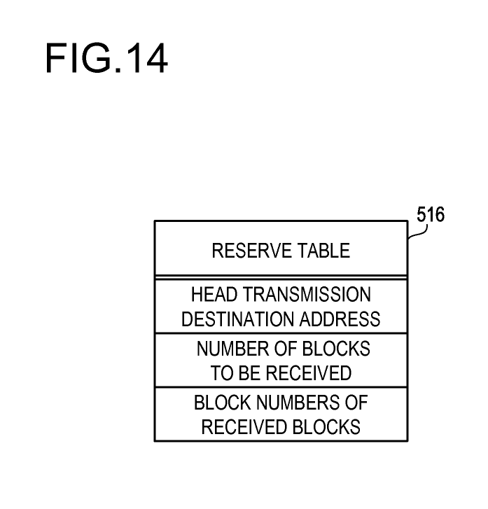

FIG. 14 is a diagram illustrating an example of a reserve table. A reserve table 516 is stored in the table memory section 512a. The reserve table 516 includes items such as a “head transmission destination address”, a “number of blocks to be received”, and “block numbers of received blocks”.

A transmission destination address at which a head data block is stored is registered in the item of the “head transmission destination address”. The number of blocks to be received is registered in the item of the “number of blocks to be received”. Numbers of blocks stored in the buffer memory section 511a by the transmission control unit 520a are registered in the item of the “block numbers of received blocks”.

Specifically, the “head transmission destination address” in the additional information is registered in the item of the “head transmission destination address”. The “number of blocks” in the additional information is registered in the item of the “number of blocks to be received”. The “block number” in the additional information is registered in the item of the “block numbers of received blocks”.

While blocks belonging to an in-process group registered in the in-process table 515 are being received, when a block belonging to a different group is received, information on the latter block is registered in the reserve table 516. The reserve table 516 temporarily holds the information on the latter block until it is determined whether the block corresponding to the registered information is an incorrect block stored in the memory 502a or a block belonging to a group transmitted subsequent to the group corresponding to the information registered in the in-process table 515.

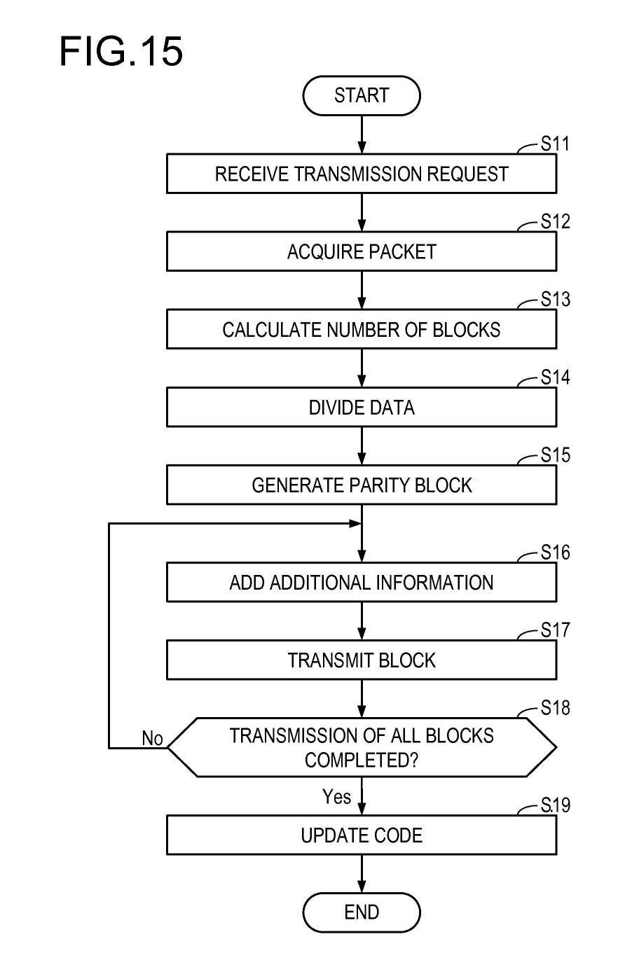

FIG. 15 is a flowchart illustrating an example of a transmission process. Hereinafter, the processing illustrated in FIG. 15 will be described.

S11: The transmission control unit 520 receives a data transmission request from the CPU core 202. The transmission control unit 520 registers the transmission source address in the RAM 205, the head transmission destination address in the RAM 205a, and the data size, which are set in the received data transmission request, in the items of the “transmission source address”, the “head transmission destination address” and the “data size” in the transmission table 513, respectively.

S12: The transmission control unit 520 requests the memory control unit 204 to read out data requested for transmission, via the PCIe control unit 203. The transceiver circuit 503 acquires the data read from the RAM 205 by the memory control unit 204, as one or more PCIe packets, via the PCIe control unit 203.

The transceiver circuit 503 stores the acquired PCIe packets in the buffer memory section 511. The transceiver circuit 503 informs the transmission control unit 520 of the fact that the PCIe packets have been stored in the buffer memory section 511. The transmission control unit 520 integrates data blocks stored in the PCIe packets. The transmission control unit 520 informs the block generating unit 530 of the fact that the transmission data have been stored in the buffer memory section 511.

S13: The block generating unit 530 calculates the number of blocks on the basis of the “transmission size”, the “additional information size” and the “data size” listed in the transmission table 513. The number of blocks is calculated according to an expression “data size/(transmission size−additional information size)”. The block generating unit 530 registers the calculated number of blocks in the transmission table 513.

S14: Based on the “transmission size” and the “additional information size” in the transmission table 513, the block generating unit 530 again divides the integrated data blocks to create plural data blocks. That is, the size of each data block after the re-division corresponds to “transmission size−additional information size”.

S15: The block generating unit 530 generates a parity block on the basis of the created data blocks. The block generating unit 530 increments the “number of blocks” in the transmission table 513. That is, a total number of the data blocks and the parity block is registered in the item of the “number of blocks” in the transmission table 513. The block generating unit 530 informs the transmission control unit 520 of the fact that the generation of the blocks has been completed.

S16: The transmission control unit 520 selects one data block or the parity block from the generated blocks. The transmission control unit 520 generates additional information including, as the items of the “code”, the “head transmission destination address”, and the “number of blocks”, the “code”, the “head transmission destination address”, and the “number of blocks” in the transmission table 513, respectively. In addition, the transmission control unit 520 sets a number indicating a selection order selected in S16, among the blocks generated in S14 and S15, in the item of the “block number” in the additional information. The transmission control unit 520 adds the generated additional information to the selected data block or parity block.

S17: The transmission control unit 520 stores the data block or parity block added with the additional information in a payload of a PCIe packet and transmits the PCIe packet to the communication circuit 500a via the transceiver circuit 504.

S18: The transmission control unit 520 determines whether or not transmission of all of the data blocks and the parity block generated in S14 and S15 has been completed. If the transmission has been completed, the process proceeds to S19. If the transmission has not yet been completed, the process proceeds to S16.

S19: The transmission control unit 520 updates the “code” in the transmission table 513. For example, the transmission control unit 520 updates the current code from “0” to “1” or “1” to “0”. Then, the process is ended.

According to the above-described process, all of the data blocks and the parity block belonging to the same group may be transmitted to the communication circuit 500a. The parity block may be transmitted after all of the data blocks are transmitted, and vice versa.

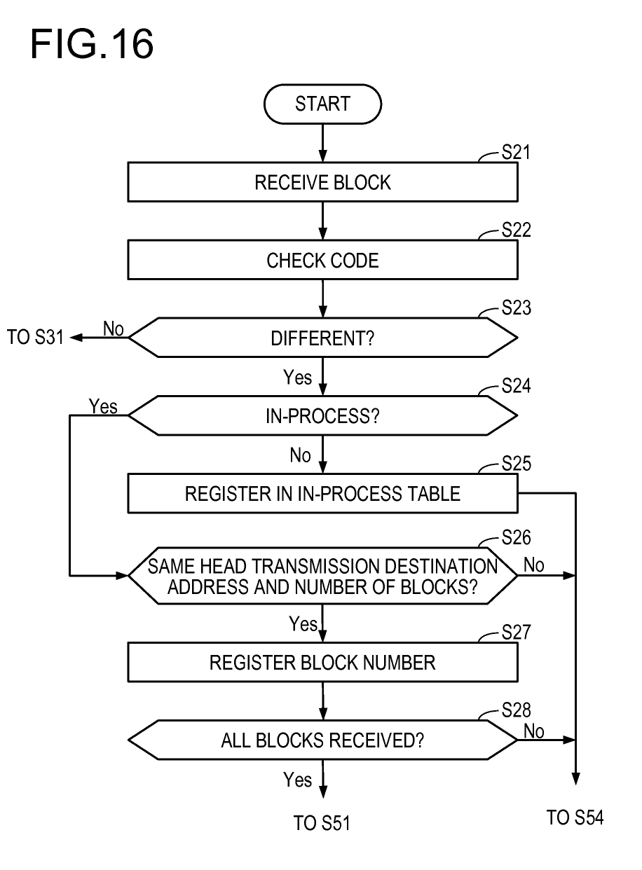

FIG. 16 is a flowchart illustrating an example of a reception process. Hereinafter, the process illustrated in FIG. 16 will be described.

S21: The transceiver circuit 504a receives one data block or the parity block. The transceiver circuit 504a stores the one data block or the parity block, together with the additional information added thereto, in the buffer memory section 511a. The transceiver circuit 504a informs the analyzing unit 530a of the fact that the one data block or the parity block has been received.

Hereinafter, the analyzing unit 530a processes the one block (data block or parity block) stored in the buffer memory section 511a by the transceiver circuit 504a.

S22: The analyzing unit 530a checks a “code” set in the additional information added to the block.

S23: The analyzing unit 530a determines whether or not the code checked in S22 is different from the “code” registered in the code management table 514. If it is determined that the codes are different from each other, the process proceeds to S24. If it is determined that the codes are equal to each other, the process proceeds to S31.

S24: The analyzing unit 530a determines whether or not data is registered in the in-process table 515. That is, the analyzing unit 530a determines whether any data is registered in the in-process table 515 or no data is registered in the in-process table 515. If it is determined that data is registered, the process proceeds to S26. If it is determined that no data is registered, the process proceeds to S25.

S25: The analyzing unit 530a registers the “head transmission destination address”, the “number of blocks”, and the “block number” set in the additional information added to the block in the “head transmission destination address”, the “number of blocks to be received”, and the “block numbers of received blocks” in the in-process table 515, respectively. The analyzing unit 530a instructs the monitoring unit 540a to monitor whether or not all blocks belonging to the same group, which is registered in the in-process table 515, are included in the buffer memory section 511a in a predetermined time. Then, in the subsequent process, processing by the analyzing unit 530a and processing by the monitoring unit 540a are performed in parallel. Then, the process proceeds to S54.

S26: The analyzing unit 530a determines whether or not the “head transmission destination address” and the “number of blocks” set in the additional information added to the block are respectively equal to the “head transmission destination address” and the “number of blocks to be received” registered in the in-process table 515. If it is determined that the “head transmission destination address” and the “number of blocks” set in the additional information added to the block are respectively equal to the “head transmission destination address” and the “number of blocks to be received” registered in the in-process table 515, the process proceeds to S27. Otherwise, the process proceeds to S54.

If it is determined that the “head transmission destination address” or the “number of blocks” set in the additional information added to the block is not equal to the “head transmission destination address” or the “number of blocks to be received” registered in the in-process table 515, the block in process may be highly likely to be an abnormal block. Therefore, the analyzing unit 530a may discard the block used for the determination, that is, the block stored in the buffer memory section 511a in S21. In addition, the analyzing unit 530a may inform the communication circuit 500 of the abnormality.

S27: The analyzing unit 530a registers the “block number” set in the additional information added to the block in the item of the “block numbers of received blocks” in the in-process table 515.

S28: The analyzing unit 530a determines whether or not all blocks belonging to the same group, which are registered in the in-process table 515, have been received. Specifically, the analyzing unit 530a determines whether or not the “number of blocks to be received” and the number of the “block numbers of received blocks” registered in the in-process table 515 are equal to each other. For example, if the “number of blocks to be received” registered in the in-process table 515 is “5” and the “block numbers of received blocks” registered in the in-process table 515 is “1” to “5”, the analyzing unit 530a determines that all blocks belonging to the same group have been received. If it is determined that all blocks have been received, the analyzing unit 530a informs the monitoring unit 540a of the fact. Then, the process proceeds to S51. If it is determined that reception of some blocks has been not yet completed, the process proceeds to S54.

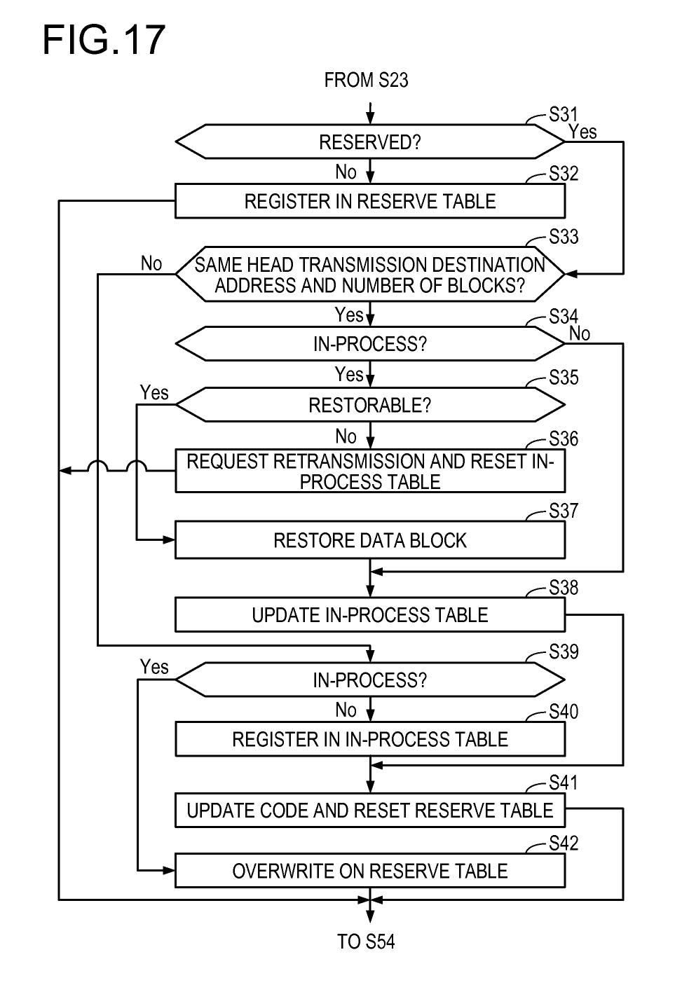

FIG. 17 is a flowchart illustrating an example of a reception process. Hereinafter, the processing illustrated in FIG. 17 will be described.

S31: The analyzing unit 530a determines whether or not data is registered in the reserve table 516. If it is determined that any data is registered, the process proceeds to S33. If it is determined that no data is registered, the process proceeds to S32.

S31: The analyzing unit 530a registers the “head transmission destination address”, the “number of blocks” and the “block number” set in the additional information added to the block in the items of the “head transmission destination address”, the “number of blocks to be received”, and the “block numbers of received blocks” in the reserve table 516, respectively. Then, the process proceeds to S54.

Here, if it is determined to be “No” in S31, this means that one block belonging to a group different from the group registered recently in the in-process table 515 is detected. In this case, it is unclear whether the detected block is a proper block corresponding to data transmitted next from the transmitting side or an unnecessary block left in the buffer memory section 511a due to, for example, a writing error. Therefore, the analyzing unit 530a temporarily holds information on the detected block in the reserve table 516 in S32. The information on the detected block is held in the reserve table 516 until the properness of the detected block is determined.

S33: The analyzing unit 530a determines whether or not the “head transmission destination address” and the “number of blocks” set in the additional information added to the block are respectively equal to the “head transmission destination address” and the “number of blocks to be received” registered in the reserve table 516. If equal, the analyzing unit 530a registers the “block number” set in the additional information added to the block stored in the buffer memory section 511a in S21 in the item of the “block numbers of received blocks” in the reserve table 516. Then, the process proceeds to S34. If not equal, the process proceeds to S39.

S34: The analyzing unit 530a determines whether or not data is registered in the in-process table 515. If it is determined that data is registered, the process proceeds to S35. If it is determined that no data is registered, the process proceeds to S38.

Here, if “Yes” is determined in both S33 and S34, it means that blocks belonging to a group different from the group registered in the in-process table 515 are continuously received. In this case, it is determined that the blocks registered in the reserve table 516 are blocks corresponding to data transmitted next and are proper blocks which are not to be discarded. Therefore, in S35 and after, processing is performed for completing reception related to the group registered in the in-process table 515.

S35: The analyzing unit 530a determines whether or not a data block, which has not yet been completed to be received, among the data blocks belonging to the group registered in the in-process table 515 may be restored, by referring to the in-process table 515. Specifically, (1) the analyzing unit 530a checks whether or not a difference between the “number of blocks to be received” registered in the in-process table 515 and the number of the “block numbers of received blocks” registered in the in-process table 515 is one. (2) If it is determined that the difference is one, the analyzing unit 530a determines whether or not the block which has not yet been completed to be received is a data block, based on the “block numbers of received blocks”. When the block which has not yet been completed to be received is a data block, the analyzing unit 530a determines that the data block may be restored. If it is determined that the restoration is possible, the analyzing unit 530a informs the restoring unit 550a of the fact. Then, the process proceeds to S37. If it is determined that the restoration is not possible, the process proceeds to S36.

If it is determined in (1) that the difference is one and if the block which has not yet been completed to be received is the parity block, the analyzing unit 530a informs the transmission control unit 520a of the fact that all data blocks are included. The transmission control unit 520a transmits all the data blocks to the RAM 205a via the PCIe control unit 203a and the memory control unit 204a. The analyzing unit 530a resets (erases) the data registered in the in-process table 515. Then, the process is ended.

S36: The analyzing unit 530a requests, via the transmission control unit 520a, the communication circuit 500 to retransmit transmission data corresponding to the group registered in the in-process table 515. The analyzing unit 530a resets the data registered in the in-process table 515. Then, the process proceeds to S54.

S37: The restoring unit 550a uses the received data blocks and the parity block registered in the in-process table 515 to restore the data block which has not yet been completed to be received. The restoring unit 550a informs the transmission control unit 520a of the fact that the data block has been restored. The transmission control unit 520a instructs the transceiver circuit 503a to transmit all data blocks belonging to the group registered in the in-process table 515 to the RAM 205a. These entire data blocks are again divided into PCIe packets and transmitted to the RAM 205a via the PCIe control unit 203a and the memory control unit 204a by the transceiver circuit 503a. Thus, all the data blocks are stored in the RAM 205a and the transmission of the data related to the group registered in the in-process table 515 is completed.

S38: The analyzing unit 530a updates the information in the in-process table 515 with the data registered in the reserve table 516. In addition, the analyzing unit 530a instructs the monitoring unit 540a to monitor whether or not all blocks belonging to the group registered in the in-process table 515 are included in the buffer memory section 511a in a predetermined time. Then, in the subsequent process, processing by the analyzing unit 530a and processing by the monitoring unit 540a are performed in parallel. Then, the process proceeds to S41.

S39: The analyzing unit 530a determines whether or not data is registered in the in-process table 515. If it is determined that data is registered, the process proceeds to S42. If it is determined that no data is registered, the process proceeds to S40.

S40: The analyzing unit 530a registers the “head transmission destination address”, the “number of blocks”, and the “block number” set in the additional information added to the block stored in the buffer memory section 511a in S21 in the in-process table 515. In addition, the analyzing unit 530a instructs the monitoring unit 540a to monitor whether or not all blocks belonging to the same group registered in the in-process table 515 are included in the buffer memory section 511a in a predetermined time. Then, in the subsequent process, processing by the analyzing unit 530a and processing by the monitoring unit 540a are performed in parallel.

S41: The analyzing unit 530a updates the “code” registered in the code management table 514 with a different value. In addition, the analyzing unit 530a resets the data registered in the reserve table 516. Then, the process proceeds to S54.

S42: The analyzing unit 530a updates the information in the reserve table 516 with the “head transmission destination address”, the “number of blocks” and the “block number” set in the additional information added to the block stored in the buffer memory section 511a in S21. Then, the process proceeds to S54.

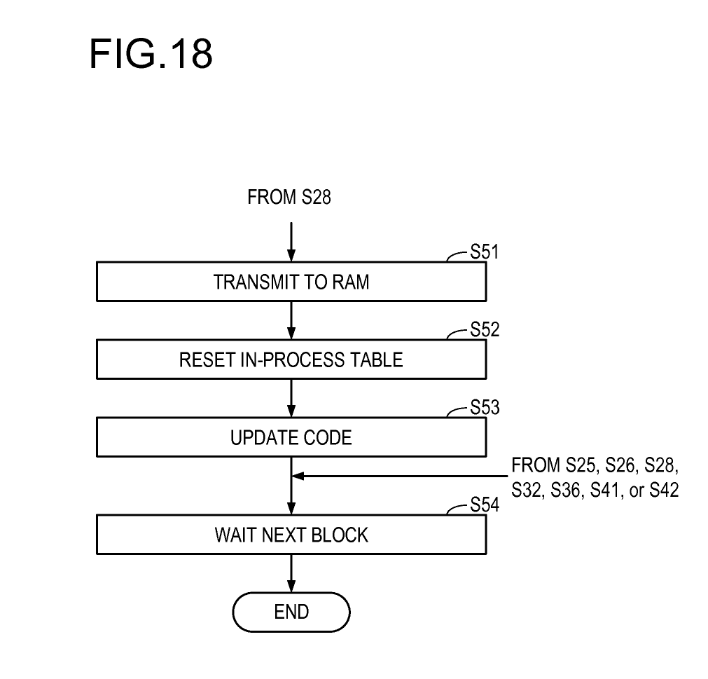

FIG. 18 is a flowchart illustrating an example of a reception process. Hereinafter, the processing illustrated in FIG. 18 will be described.

S51: The transmission control unit 520a instructs the transceiver circuit 503a to transmit all data blocks belonging to the group registered in the in-process table 515 to the RAM 205a. These entire data blocks are again divided into PCIe packets and transmitted to the RAM 205a via the PCIe control unit 203a and the memory control unit 204a by the transceiver circuit 503a. Thus, all the data blocks are stored in the RAM 205a. The transmission control unit 520a informs the analyzing unit 530a of the fact that all the data have been transmitted.

S52: The analyzing unit 530a resets the data registered in the in-process table 515.

S53: The analyzing unit 530a updates the “code” registered in the code management table 514 with a different value.

S54: The analyzing unit 530a waits for the next data block. Then, the process is ended.

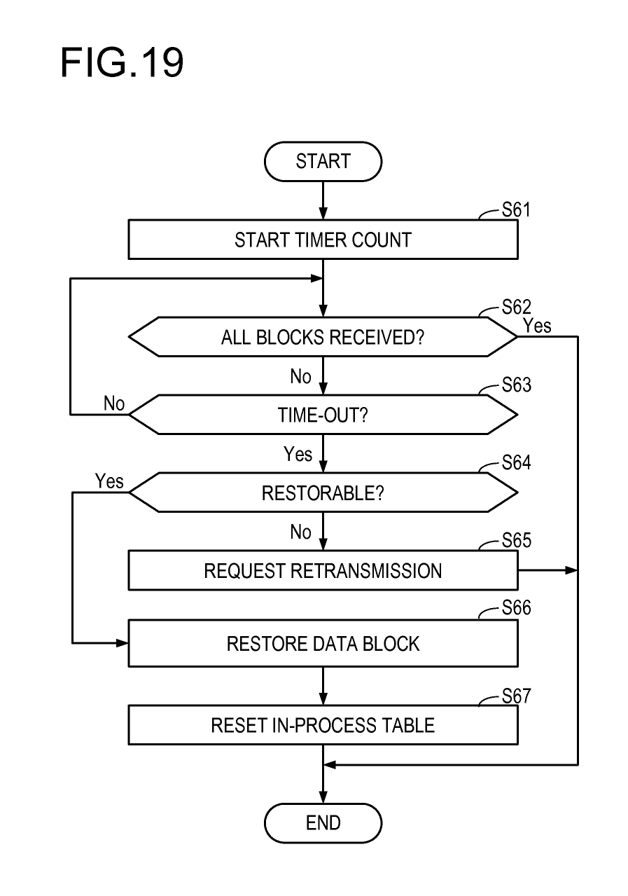

FIG. 19 is a flowchart illustrating an example of a monitoring process. Hereinafter, the processing illustrated in FIG. 19 will be described. The monitoring process begins after the monitoring unit 540a receives, from the analyzing unit 530a, an instruction to monitor whether or not all blocks belonging to the group registered in the in-process table 515 are included in the buffer memory section 511a in a predetermined time.

S61: The monitoring unit 540a starts count of a timer. The monitoring unit 540a performs the following S62 and S63 at a predetermined time interval.

S62: The monitoring unit 540a determines whether or not all the blocks belonging to the group registered in the in-process table 515 have been completely received. The monitoring unit 540a may make this determination by being informed by the analyzing unit 530a of the fact that all the blocks belonging to the group registered in the in-process table 515 have been received (see S28 in FIG. 16). If it is determined that all the blocks have been received, the process is ended. If it is determined that some of the blocks have not been received, the process proceeds to S63.

S63: The monitoring unit 540a determines whether or not the predetermined period of time elapses after the count of the timer is started. That is, the monitoring unit 540a determines whether or not time-out occurs. If it is determined that a time-out occurs, the process proceeds to S64. If it is determined that no time-out occurs, the process proceeds to S62.

S64: The monitoring unit 540a determines whether or not a data block which has not yet been completed to be received may be restored, by referring to the in-process table 515. This determination by the monitoring unit 540a is similar to the determination by the analyzing unit 530a in S35. If it is determined that the restoration is possible, the monitoring unit 540a informs the restoring unit 550a of the fact. Then, the process proceeds to S66. If it is determined that the restoration is not possible, the process proceeds to S65.

If all the data blocks belonging to the group have been completed to be received, the monitoring unit 540a informs the transmission control unit 520a of the fact. The transmission control unit 520a transmits all the data blocks to the RAM 205a via the PCIe control unit 203a and the memory control unit 204a. The monitoring unit 540a resets the data registered in the in-process table 515. Then, the process is ended.

S65: The monitoring unit 540a requests, via the transmission control unit 520a, the communication circuit 500 to retransmit transmission data corresponding to the group registered in the in-process table 515. Then, the process is ended.

S66: The restoring unit 550a uses the received data blocks and the parity block registered in the in-process table 515 to restore the data block which has not yet been completed to be received. The restoring unit 550a informs the transmission control unit 520a of the fact that the data block has been restored. The transmission control unit 520a instructs the transceiver circuit 503a to transmit all data blocks belonging to the group registered in the in-process table 515 to the RAM 205a. These entire data blocks are again divided into PCIe packets and transmitted to the RAM 205a via the PCIe control unit 203a and the memory control unit 204a by the transceiver circuit 503a. Thus, all the data blocks are stored in the RAM 205a and the transmission of the data related to the group registered in the in-process table 515 is completed.

S67: The monitoring unit 540a resets the data registered in the in-process table 515. Then, the process is ended.

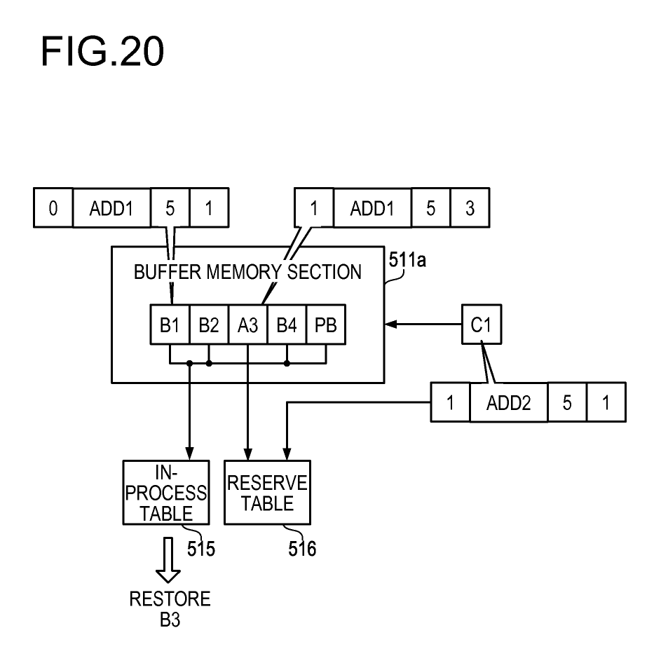

FIG. 20 is a diagram illustrating an example of a reception process. FIG. 20 illustrates a case where a writing error in a buffer area occurs as described in FIGS. 6 and 8.

In FIG. 20, it is first assumed that transmission of data A is requested and data blocks A1 to A4 obtained by dividing the data A and a parity block PA based on the data blocks A1 to A4 are stored in the buffer memory section 511a. The data A, the data blocks A1, A2, and A4 and the parity block PA are not illustrated in FIG. 20. It is also assumed that additional information added to these blocks is set with a code “1”, a head transmission destination address “ADD1” and the number of blocks “5”.

In this state, it is assumed that transmission of data B having the same transmission destination and data size as the data A is requested. The data B is divided into data blocks B1 to B4 and a parity block PB is generated based on the data blocks B1 to B4. Additional information added to these blocks is set with a code “0”, a head transmission destination address “ADD1” and the number of blocks “5”. The data block B3 is not illustrated in FIG. 20. It is also assumed that these data blocks B1 to B4 and the parity block PB are to be written in the same memory area as the data blocks A1 to A4 and the parity block PA in the buffer memory section 511a.

It is first assumed that the data blocks A1 and A2 are overwritten by the data blocks B1 and B2, respectively. At this point, the code “1” is registered in the code management table 514 and the head transmission destination address “ADD1”, the number of blocks to be received “5”, and the block numbers of received blocks “1” and “2” are registered in the in-process table 515.

It is here assumed that the transmission control unit 520a fails in writing of the data block B3 and the data block A3 is left in the buffer memory section 511a. At this time, the additional information of the data block A3 is read and, since the code is “1”, information on the data block A3 is registered in the reserve table 516 (which corresponds to S32 in FIG. 17).

Next, if writing of the data block B4 and the parity block PB is successful, the data block B4 and the parity block PB are registered in the item of the “block numbers of received blocks” in the in-process table 515. However, since the block numbers of received blocks corresponding to the data B is“4”, it is not determined that all blocks corresponding to the data B have been completed to be received (which corresponds to “No” in S28 in FIG. 16).

Next, it is assumed that a data block C1 generated from data C (not illustrated) has been received. Additional information of the data block C1 is set with a code “1”, a head transmission destination address “ADD2” and the number of blocks “5”. In this case, the data block A3 registered in the reserve table 516 is determined as invalid data and the reserve table 516 is updated with the additional information of the data block C1 (which corresponds to S42 in FIG. 17).

In addition, if a time-out occurs for the data B because a block corresponding to the data B is not received in a predetermined time from reception of the parity block PB, the data block B3 which has not been completed to be received (that is, has failed to be written) is restored (which corresponds to S66 in FIG. 19).

According to the above-described processing, transmission of the data B may be normally completed even when the data block B3 fails to be written. In addition, the data block A3 left in the buffer memory section 511a due to a failure in writing may be determined and discarded as unnecessary data.

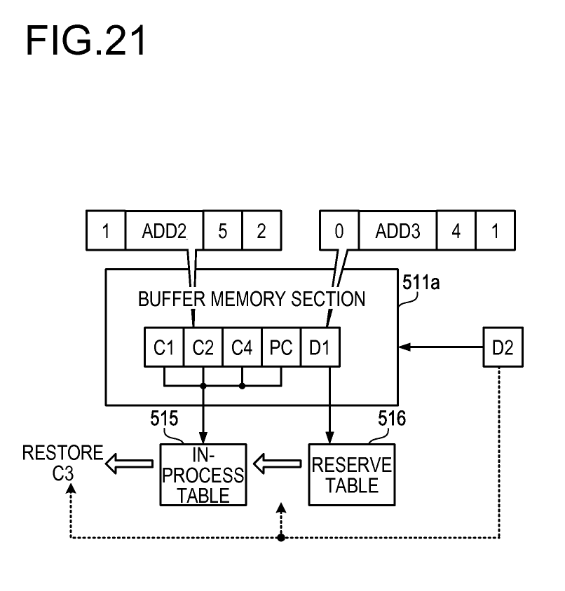

FIG. 21 is a flowchart illustrating an example of a reception process. FIG. 21 illustrates a case where a reception missing of a block occurs due to, for example, a packet loss on a transmission line.

In FIG. 21, it is first assumed that transmission of data C is requested and data blocks C1 to C4 obtained by dividing the data C and a parity block PC based on the data blocks C1 to C4 are transmitted from the communication circuit 500 to the communication circuit 500a. Additional information added to these blocks is set with a code “1”, a head transmission destination address “ADD2” and the number of blocks “5”.

It is, however, assumed that the data block C3 has been lost during transmission and the data blocks C1, C2 and C4 and the parity block PC have been stored in this order in the buffer memory section 511a of the communication circuit 500a. In this state, for example, code “0” is registered in the code management table 514 and the head transmission destination address “ADD2”, the number of blocks to be received “5” and the block numbers of received blocks “1”, “2”, “4” and “5” are registered in the in-process table 515. The data C and the data block C3 are not illustrated in FIG. 21.

It is also assumed that transmission of data D (not illustrated) has been requested and a data block D1 obtained by dividing the data D has been stored in the buffer memory section 511a. Additional information of the data block D1 is set with a code “0”, a head transmission destination address “ADD3” and the number of blocks “4”. In this case, information on the data block D1 is registered in the reserve table 516 (which corresponds to S32 in FIG. 17).

It is here assumed that a data block D2 obtained by dividing the data D has been stored in the buffer memory section 511a. In this case, a block number set in additional information of the data block D2 is additionally registered, as the “block numbers of received blocks”, in the reserve table 516. This refers to reception of two blocks belonging to a group other than those registered in the in-process table 515. Therefore, processing for ending the reception process of the groups registered in the in-process table 515 is performed (which corresponds to “Yes” in S34 in FIG. 17).

In the case of FIG. 21, the data block C3 is restored, the data blocks C1 to C4 are written in the RAM 205a, and the transmission of the data C is normally ended (which corresponds to S37 in FIG. 17). Then, the information in the in-process table 515 is updated with the information on the data blocks D1 and D2 registered in the reserve table 516 (which corresponds to S38 in FIG. 17).

According to the above-described processing, in a situation where the data block C3 is lost and a block, which has been unsuccessfully received, is present among blocks corresponding to the data C, when blocks corresponding to the next data D are transmitted, it may be estimated that the data block C3 is lost, and the data block C3 may be restored. In addition, the data blocks D1 and D2 may be determined as proper blocks corresponding to the subsequent data D.

In a state where the data blocks C1, C2 and C4, the parity block PC, and the data block D1 are stored in the buffer memory section 511a, the following processing is performed when a time-out occurs in the data C. First, processing for ending the reception process of the group registered in the in-process table 515 is performed (which corresponds to “Yes” in S63 in FIG. 19). In the case of FIG. 21, the data block C3 is restored, the data blocks C1 to C4 are written in the RAM 205a, and the transmission of the data C is normally ended (which corresponds to S66 in FIG. 19). Next, the information in the in-process table 515 is reset (which corresponds to S67 in FIG. 19).

According to the above-described processing, in a situation where the data block C3 is lost and a block, which has been unsuccessfully received, is present among blocks corresponding to the data C, when blocks corresponding to the next data D are transmitted, it may be estimated that the data block C3 is lost, and the data block C3 may be restored. With the information on the data block D1 registered in the reserve table 516, for example, when the next data block D2 is received, the information on the data blocks D1 and D2 is moved from the reserve table 516 to the in-process table 515 (which corresponds to “No” in S38 in FIG. 17). Accordingly, it is determined that proper blocks corresponding to the subsequent data are being received.

It is assumed in the above-described second embodiment that one block (data block or parity block) is stored in one PCIe packet in the data transmission from the communication circuit 500 to the communication circuit 500a. However, the size of “additional information+block” may be larger than that of the payload of a PCIe packet with no need to make this size equal to the size of the payload. In order to detect a reception error on a transmission line by the unit of block, however, it is undesirable that a plurality of blocks are included in the payload of the PCIe packet. Therefore, it is desirable to define the block size such that the size of “additional information+a block” is equal to or more than two times as large as the size of the payload.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiver, comprising:
a processor configured to
receive first data blocks and a first parity block from a transmitter, the first data blocks being obtained by dividing first transmission data at a predetermined size, the first parity block being generated on basis of the first data blocks, and
restore a first missing block on basis of first received blocks and the first parity block, the first missing block being an unsuccessfully received block of the first data blocks, the first received blocks being successfully received blocks of the first data blocks, the first parity block being successfully received.

2. The receiver according to claim 1, wherein
first information is added to each of the first data blocks and the first parity block, the first information indicating a first group corresponding to the first transmission data, and
the processor is configured to
discriminate, on basis of the first information, the first received blocks and the first parity block from second data blocks and a second parity block, the second data blocks being obtained by dividing second transmission data different from the first transmission data, the second parity block being generated on basis of the second data blocks.

3. The receiver according to claim 2, wherein
second information is added to each of the first data blocks and the first parity block, the second information indicating a number of the first data blocks,
third information is added to each of the first data blocks and the first parity block, the third information indicating a serial number assigned to each of the first data blocks and the first parity block in the first group, and
the processor is configured to
determine the first missing block on basis of the second information and the third information added to each of the first received blocks and the first parity block.

4. The receiver according to claim 2, further comprising:
a buffer memory,
wherein
second information is added to each of the first data blocks and the first parity block, the second information indicating a first value or a second value different from the first value, the second information being switched between the first value and the second value every time transmission data to be transmitted is switched, and
the processor is configured to
temporarily store the first received blocks and the first parity block in the buffer memory together with the first information and the second information, and
discriminate the first received blocks and the first parity block from the second data blocks and the second parity block on basis of the first information and the second information.

5. The receiver according to claim 2, wherein
the first transmission data is requested to be written in a first memory device, and
the first information indicates a head address of a write destination area in which the first transmission data is to be written in the first memory device.

6. The receiver according to claim 5, wherein
the receiver is a storage controller for controlling access to the first memory device, and
the first transmission data is stored in a second memory device different from the first memory device.

7. A transmitter, comprising:
a buffer memory configured to
temporarily store first transmission data to be transmitted to a receiver; and
a processor configured to
obtain first data blocks by dividing the first transmission data stored in the buffer memory at a predetermined size,
generate a first parity block on basis of the first data blocks,
add first information to each of the first data blocks and the first parity block, the first information indicating a first group corresponding to the first transmission data, and
transmit the first data blocks and the first parity block together with the first information to the receiver.

8. The transmitter according to claim 7, wherein
the processor is configured to
add second information to each of the first data blocks and the first parity block, the second information indicating a number of the first data blocks,
add third information to each of the first data blocks and the first parity block, the third information indicating a serial number assigned to each of the first data blocks and the first parity block in the first group, and
transmit the first data blocks and the first parity block together with the first information, the second information, and the third information to the receiver.

9. The transmitter according to claim 7, wherein
the processor is configured to
add second information to each of the first data blocks and the first parity block, the second information indicating a first value or a second value different from the first value, and
switch the second information between the first value and the second value every time transmission data to be transmitted is switched.

10. The transmitter according to claim 7, wherein
the first transmission data is requested to be written in a first memory device, and
the first information indicates a head address of a write destination area in which the first transmission data is to be written in the first memory device.

11. The transmitter according to claim 10, wherein
the transmitter is a storage controller for controlling access to a second memory device different from the first memory device, and
the first transmission data is stored in the second memory device.

12. A data transmission system, comprising:
a transmitter including
a first processor configured to
obtain first data blocks by dividing first transmission data at a predetermined size,
generate a first parity block on basis of the first data blocks, and
transmit the first data blocks and the first parity block; and
a receiver including
a second processor configured to
receive the first data blocks and the first parity block from the transmitter, and
restore a first missing block on basis of first received blocks and the first parity block, the first missing block being an unsuccessfully received block of the first data blocks, the first received blocks being successfully received blocks of the first data blocks, the first parity block being successfully received.

13. The data transmission system according to claim 12, wherein
the first processor is configured to
add first information to each of the first data blocks and the first parity block, the first information indicating a first group corresponding to the first transmission data, and
transmit the first data blocks and the first parity block together with the first information to the receiver, and
the second processor is configured to
discriminate the first received blocks and the first parity block from second data blocks and a second parity block on basis of the first information, the second data blocks being obtained by dividing second transmission data different from the first transmission data, the second parity block being generated on basis of the second data blocks.

14. The data transmission system according to claim 13, wherein
the first processor is configured to
add second information to each of the first data blocks and the first parity block, the second information indicating a number of the first data blocks,
add third information to each of the first data blocks and the first parity block, the third information indicating a serial number assigned to each of the first data blocks and the first parity block in the first group, and
transmit the first data blocks and the first parity block together with the first information, the second information, and the third information to the receiver, and
the second processor is configured to
determine the first missing block on basis of the second information and the third information added to each of the first received blocks and the first parity block.

15. The data transmission system according to claim 13, wherein
the first processor is configured to
add second information to each of the first data blocks and the first parity block, the second information indicating a first value or a second value different from the first value, and
switch the second information between the first value and the second value every time transmission data to be transmitted is switched,
the receiver further includes a buffer memory, and
the second processor is configured to
temporarily store the first received blocks and the first parity block in the buffer memory together with the first information and the second information, and
discriminate the first received blocks and the first parity block from the second data blocks and the second parity block on basis of the first information and the second information.

16. The data transmission system according to claim 13, wherein
the first transmission data is requested to be written in a first memory device, and
the first information indicates a head address of a write destination area in which the first transmission data is to be written in the first memory device.

17. The data transmission system according to claim 16, wherein
the transmitter is a storage controller for controlling access to a second memory device different from the first memory device,
the receiver is a storage controller for controlling access to the first memory device, and
the first transmission data is stored in the second memory device.
